(19) United States
(12) Patent Application Publication
(10) Pub. No.: US 2003/0040433 A1
(43) Pub. Date: Feb. 27, 2003

(54) Synergistic, layered, precious metal-base metal hydrogenation catalysts

(76) Inventor: Leslie C. Case, Newfields, NH (US)

Correspondence Address: Leslie Catron Case, 152 Piscassid Road, Newfields, NH, 03856, US

(21) Appl. No.: 09/939,862

(22) Filed: Aug. 27, 2001

(51) Int. Cl. B01J 25/00; B01J 23/00

(52) U.S. Cl. 502/527.12; 502/301; 502/325; 502/326

(57) ABSTRACT

This invention is the new and useful embodiment of a long-recongized principle—that heterogeneous catalysis takes place in at least two steps, (1) hydrogen is taken up (absorbed) by the catalyst, and (2) that absorbed hydrogen that undergoes the further catalytic reaction.

The instant invention divides the two steps between two cooperative and intimately connected layers—(b) a substantial layer of base metal, which absorbs the hydrogen, and then supplies it rapidly to (2) a much less massive layer of precious metal capable of effecting the desired catalysis.

The unexpected and very useful advantage of this invention is that it provides very useful rates of heterogeneous catalytic hydrogenation at far lower requirement of precious metal compared to a catalyst body employing precious metal alone.

### BACKGROUND OF THE INVENTION

Heterogeneous hydrogenation-dehydrogenation catalysts have long been known, and are in widespread commercial use in the chemical and petroleum-refining industries. It is also long been known that the catalysts employing precious metals (such as platinum, palladium, rhodium, and sometimes ruthenium or rhenium) generally have greater activity, and greater specificity, than the base-metal catalysts, such as nickel, cobalt, iron, copper chromite, etc.

Contrariwise, these precious metals are much less plentiful, and much more costly, than the base metals. The high cost, and very limited availability, of the precious metals have severe impact on those instances where the precious metal catalysts are very much preferred in large-scale applications. The most notable instance of this impact is in fuel cells. A platinum catalyst is currently very preferred for fuel cells for powering automobiles, but the current state of the art requires about ⅓ to ½ ounce of Pt for an auto fuel cell. Because the total annual mining production of Pt is only about 5 million ounces, and especially because the Pt has numerous important uses which currently use up the mined Pt, there is no possibility with current technology that automobile fuel cells can be other than a limited, niche market. And any other projected new, large-scale application of precious metal catalysts runs into the very same constraint.

### BRIEF DESCRIPTION OF THE INVENTION

I have discovered that the deposition of a very thin layer of precious metal onto an existing layer or mass of base metal which is permeable to, and absorptive of, hydrogen yields a new catalyst composition which duplicates the existing precious metal catalysts, at a lower precious metal content. This appears not to be a “doping” effect, but rather a synergistic interaction between the respective layers. The base metal layer absorbs hydrogen, and supplies that hydrogen to the precious metal layer. The precious metal layer need be present in only sufficient quantity to undergo to appropriate catalytic reaction.

These compositions are also useful with heavy hydrogen (deuterium).

The precious metal may be platinum, palladium, rhodium, iridium, ruthenium, or rhenium. Platinum and palladium are preferred. The amount of precious metal may range from about 0.01% to about 1% by weight of the total composite, with an amount of from about 0.05% to about 0.1% being preferred.

The base metal layer may be nickel (preferred), cobalt, iron, copper or copper chromite, thorium, or a rare earth, or mixture of rare earths, etc. Any base metal, or alloy or compound thereof, which is permeable to, and absorptive of, hydrogen is a candidate. It appears to be preferred that the base metal layer is porous, allowing fast transport of the hydrogen in the interstices.

And the base metal layer may be in the form of a layer deposited onto a substrate, such as activated carbon, silica, alumina, a ceramic, or kieselguhr, and in this case, the ultimate composition is a multi-layer composite.

### DETAILED DESCRIPTION OF THE INVENTION

The principle behind this invention is that heterogenous hydrogenation may be considered as a two-step process: (1) Hydrogen must be taken up by the catalyst, and (2) The hydrogen must then undergo the desired reaction. I have now found that these two steps can be performed by different layers of a composite catalyst. Quite unexpectedly, it has been found that only a very small or thin layer of precious metal catalyst can yield a satisfactory rate of reaction, if bonded closely to a substantial layer of base metal which acts as a reservoir of hydrogen, and which rapidly transfers the hydrogen to the precious metal layer. The precious metal layer can be so minimized that standing alone, it could not take up sufficient hydrogen to enable a satisfactory reaction rate. In sum, this invention provides the activity of a precious metal catalyst, at a greatly reduced useage of that metal. This is in contrast to the known “doping” formulations, wherein an increase of only something like 50% to 100% in activity is obtained by the inclusion of a small proportion of a foreign “Dopant” directly into the structure of the precious metal layer itself.

The precious and base metal layers in this composite are in immediate atom-to-atom contact, and not spaced beyond atomic distances.

Precious Metal Layer

Generally, the precious metal layer is deposited onto a previously formed base metal layer. Various methods of deposition can be employed, but must be such as to closely bond the precious metal to the base metal. Thus, the base metal may be immersed into a solution of the precious metal salt, and then adsorbed precious metal reduced in situ. Or the precious metal salt solution may be sprayed onto the base metal. Or, the precious metal may be plated onto the base metal, but this may not be preferred because plated metals are sometimes not catalytically active. Rarely, the precious metal may be sputtered onto the base metal. (Typical preparations of precious metal catalysts—in this case catalyst layers—are given in Organic Syntheses, Coll. Vol. I, pp. 463, 446, 470; Ibid, Coll. Vol. II, p. 566; Ibid, Coll. Vol. III, pp. 520, 685, 686, 687, 689; Ibid, Coll. Vol. IV, pp. 612-613). Reduction to a colloidal metal, with subsequent deposition is not preferred because the colloid does not achieve the desired extremely close contact with the base metal on deposition.

In all cases, the base metal layer may be considered the “substrate” normally employed to “support” a precious metal catalyst. And when the base metal layer itself is laid down onto s substrate, the resultant composition may be a tri-layered affair, itself a useful novelty.

The precious metal layer comprises from about 0.01% to about 1% by weight of the total catalytic composition, with a range of from about 0.5% to about 0.2% frequently preferred for good activity, consistent with minimum cost. Sometimes, especially with minimum catalyst activity requirements, less than 0.01% may be employed. In general, compositions containing about 0.5% and higher are not economically justified.

The precious metal may be selected from the group consisting of Pt, Pd, Rh, or sometimes Ru, Ir, or Re (which is a precious metal for our purposes here). In general Pt and/or Pd are preferred, although Rh may be advantageously employed in special cases. And the precious metal layer may be of a single such element, or in some cases a mixture of two or more such metals may be used. And a “dopant” amount of non-precious metal may be rarely be included in the precious metal layer.

Base Metal Layer

The base metal layer must be absorptive of, and permeable to, hydrogen, but otherwise can be widely varied in nature. It may be metallic, such as Ni, Co, Fe, or even Cu, and can be a mixture or alloy thereof. Or it can be a rare earth, or rare earth mixture, or even Th, or U. Alloys of rare earths, or rare earth mixtures, with Ni may be favored. (Such alloys are known to be very good absorbers of hydrogen).

Or the base metal layer may actually not be a metal, but rather a compound—copper chromite being useful.

Ni is generally a preferred base metal. It generally works well when coated with a thin precious metal layer. Also, insofar as Ni itself is a catalyst, one can optimize a Ni catalyst, and then further improve it greatly with a very thin Pt or Pd layer.

The preferred Ni layers are Ni or Kieselguhr, Raney Ni, and Ni black (finely powdered Ni, or precipitated colloidal Ni.) All of these Ni base metal layers are available commercially. (Raney nickel catalysts are described in some detail in Org. Syn. Coll. Vol. III, pp. 176-180).

Iron is also a preferred base metal, because of its very low cost and abundant availability. To take advantage of the very low cost, the iron is desirably used in a form requiring little processing from its as-mined, or otherwise as-obtained form. Thus, naturally powdered (linonite) or ground iron ores, are desirably employed in the (necessarily) reduced state. Specifically, such fine iron oxide dust may be contacted with a very low content of precious metal salts, from solution, vacuum dried, reduced with hydrogen, and used in situ as a catalyst. When ruthenium is the precious metal used, these catalysts are remarkably inexpensive, being among the very lowest cost hydrogenation catalysts.

A third type of preferred base metal layer is finely divided rare earth, or rare earth alloy, or rare earth alloy with nickel. These can be relatively inexpensive, because such alloys can be prepared from the natural mixture of unrefined rare earths. And they are valuable because they can absorb and hold quite large quantities of hydrogen. Such alloys are well known, and have specific utilities, but not previously known as catalysts.

The general requirement for a base metal layer is that it must be, or contain, a substantial proportion of a base metal. And it must absorb hydrogen to a high degree. I define that absorption power as follows—50 grams of the base metal is placed into a 1.6 liter pressure vessel. The vessel is sealed, evacuated and then filled to 15 psig with hydrogen at 50° C. If the pressure drops below 10 psig within 6 hours, the material is a candidate for a base metal layer.

### EXAMPLE I

Fuel cells have been optimized, using both Ni and Pt as the working catalytic metals. The Ni fuel cells work well, but must be operated with a very high starting temperature, which is not satisfactory for use in automobiles, which must start quickly. Pt fuel cells are thus preferred for autos, but use near ½ ounce of Pt per auto, which is far too high for such a mass market, given the very limited mining production of Pt.

Using the instant invention, a Ni fuel cell membrane, optimized for high-temperature Ni use, is coated with 0.1% by weight of Pt on the Ni. The thus-modified membrane then shows activity comparable to the known optimized Pt fuel cell membranes.

### EXAMPLE II

Well known, and generally useful, hydrogenation catalysts are the Pd on activated carbon catalysts. But in many uses, the level of Pd loading must be about 0.5% by weight to show good activity.

Using the instant invention, a Ni-on-kieselguhr catalyst, having a Ni content of about 50 to 70% by weight, is dampened with PdCl₂, and vacuum dried, to yield about 0.1% Pd by total weight of the resultant mass. This resultant catalyst shows better general activity than 0.5% Pd on activated carbon. And this resultant catalyst shows a strong exotherm when exposed to deuterium gas at 200° C.

### EXAMPLE III

Reduced iron ores are produced commercially for production of ammonia. When such a commercial-grade catalyst is dipped into 0.1% ruthenium chloride, and vacuum dried, The resultant product produced according to the instant invention shows increased activity in the production of ammonia.

I claim:

1. A composite catalyst, useful for heterogeneous reactions involving hydrogen, comprising a layer of from about 0.01% to 1% by weight of precious metal in non-spaced contact with a base metal layer or mass, which base metal is permeable to, and absorptive of, hydrogen.

2. The composition of claim 1 in which the precious metal is selected from the group consisting of Pt, Pd, Rh, Ir, Ru, and Re.

3. The composition of claim 1 in which the precious metal comprises from about 0.01% to about 1% of the total composite.

4. The composition of claim 1 in which the precious metal comprises from about 0.05% to about 0.2% of the composite.

5. The composition of claim 1 in which the precious metal is Pt.

6. The composition of claim 1 in which the precious metal is Pd.

7. The composition of claim 1 in which the precious metal is Rh.

8. The composition of claim 1 in which the base metal is Ni, deposited on kieselguhr.

9. The composition of claim 1 in which the base metal is powdered Ni.

10. The composition of claim 1 in which the base metal is a Raney metal, selected from the group consisting of Raney Ni, Raney Co, and Raney Fe.

11. The composition of claim 1 in which the base metal layer is a membrane optimized for use in a fuel cell.

12. The composition of claim 1 in which the base metal layer is granular.

13. The composition of claim 1 in which the base metal layer is in the form of chips.

14. The composition of claim 1 in which the base metal layer is a powder.

15. The composition of claim 1 in which the base metal layer is a reduced iron ozide.
